(19) United States
(12) Patent Application Publication
(10) Pub. No.: US 2024/0242123 A1
(43) Pub. Date: Jul. 18, 2024

(54) INFORMATION PROCESSING APPARATUS, INFORMATION PROCESSING METHOD, AND STORAGE MEDIUM

(71) Applicant: NEC Corporation, Minato-ku, Tokyo (JP)

(72) Inventors: Yuta HATAKEYAMA, Tokyo (JP); Yuzuru OKAJIMA, Tokyo (JP)

(73) Assignee: NEC Corporation, Minato-ku, Tokyo (JP)

(21) Appl. No.: 18/561,354

(22) PCT Filed: May 27, 2021
(86) PCT No.: PCT/JP2021/020174

§ 371 Date: Nov. 16, 2023

(51) Int. Cl. G06N 20/00

(52) U.S. Cl. CPC G06N 20/00

(57) ABSTRACT

In order to generate a synthetic instance in a region short of a training instance for use in training in machine learning, an information processing apparatus (10) includes: an acquisition section (11) for acquiring a plurality of training instances; a training section (12) for training, with use of the plurality of training instances, a machine learning model group that includes a plurality of machine learning models each of which outputs a prediction result while using instances as input; a selection section (13) for selecting, among the plurality of training instances, a training instance which derives variation in a plurality of prediction results obtained by using the machine learning model group which has been trained; and a generation section (14) for generating a synthetic instance by combining, among the plurality of training instances, two or more training instances including the training instance which has been selected.

### TECHNICAL FIELD

The present invention relates to a technique for generating an instance to be used in machine learning.

### BACKGROUND ART

It is known that accuracy of inference by a machine learning model depends on the number and content of training instances used in constructing the machine learning model. A technique is known in which, in order to improve inference accuracy of a machine learning model, a training instance is reinforced by generating a synthetic instance from training instances which have been prepared in advance. For example, Non-patent Literature 1 indicates that an instance (training instance) of a minority class that is nearest to a decision boundary of a support vector machine and an instance of a minority class near that instance are combined to generate a virtual instance of a minority class.

### CITATION LIST

### Non-Patent Literature

[Non-patent Literature 1]
Seyda Ertekin, “Adaptive Oversampling for Imbalanced Data Classification”, Information Sciences and Systems 2013, proceedings of the 28th International Symposium on Computer and Information Sciences (ISCIS), pp. 261-269, 2013

### SUMMARY OF INVENTION

### Technical Problem

However, the technique disclosed in Non-patent Literature 1 has a problem that a virtual instance (synthetic instance) is generated near the decision boundary, and a synthetic instance is not generated in a region which is not near the decision boundary and which is short of a training instance.

An example aspect of the present invention is accomplished in view of the above problem, and an example object thereof is to provide a technique that makes it possible to generate a synthetic instance in a region which is short of a training instance for use in training of machine learning.

### Solution to Problem

An information processing apparatus in accordance with an example aspect of the present invention includes: an acquisition means for acquiring a plurality of training instances; a training means for training, with use of the plurality of training instances, a machine learning model group that includes a plurality of machine learning models each of which outputs a prediction result while using instances as input; a selection means for selecting, among the plurality of training instances, a training instance which derives variation in a plurality of prediction results obtained by using the machine learning model group which has been trained; and a generation means for generating a synthetic instance by combining, among the plurality of training instances, two or more training instances including the training instance which has been selected.

An information processing method in accordance with an example aspect of the present invention includes: acquiring a plurality of training instances; training, with use of the plurality of training instances, a machine learning model group that includes a plurality of machine learning models each of which outputs a prediction result while using instances as input; selecting, among the plurality of training instances, a training instance which derives variation in a plurality of prediction results obtained by using the machine learning model group which has been trained; and generating a synthetic instance by combining, among the plurality of training instances, two or more training instances including the training instance which has been selected.

A program in accordance with an example aspect of the present invention is a program for causing a computer to function as an information processing apparatus, the program causing the computer to function as: an acquisition means for acquiring a plurality of training instances; a training means for training, with use of the plurality of training instances, a machine learning model group that includes a plurality of machine learning models each of which outputs a prediction result while using instances as input; a selection means for selecting, among the plurality of training instances, a training instance which derives variation in a plurality of prediction results obtained by using the machine learning model group which has been trained; and a generation means for generating a synthetic instance by combining, among the plurality of training instances, two or more training instances including the training instance which has been selected.

### Advantageous Effects of Invention

According to an example aspect of the present invention, it is possible to generate a synthetic instance in a region which is short of a training instance for use in training of machine learning.

### BRIEF DESCRIPTION OF DRAWINGS

FIG. 1 is a block diagram illustrating a configuration of an information processing apparatus in accordance with a first example embodiment of the present invention.

FIG. 2 is a flowchart illustrating a flow of an information processing method in accordance with the first example embodiment of the present invention.

FIG. 3 is a diagram schematically illustrating a specific example of the information processing method in accordance with the first example embodiment of the present invention.

FIG. 4 is a diagram schematically illustrating a synthetic instance that is generated in the first example embodiment of the present invention.

FIG. 5 is a block diagram illustrating a configuration of an information processing apparatus in accordance with a second example embodiment of the present invention.

FIG. 6 is a flowchart illustrating a flow of an information processing method in accordance with the second example embodiment of the present invention.

FIG. 7 is a diagram schematically illustrating a specific example of the information processing method in accordance with the second example embodiment of the present invention.

FIG. 8 is a flowchart illustrating a flow of a first generation process in accordance with the second example embodiment of the present invention.

FIG. 9 is a flowchart illustrating a flow of a second generation process in accordance with the second example embodiment of the present invention.

FIG. 10 is a flowchart illustrating a flow of a third generation process in accordance with the second example embodiment of the present invention.

FIG. 11 is a flowchart illustrating a flow of an information processing method in accordance with a third example embodiment of the present invention.

FIG. 12 is a flowchart illustrating a flow of an information processing method in accordance with a fourth example embodiment of the present invention.

FIG. 13 is a diagram schematically illustrating an information processing method in accordance with a fifth example embodiment of the present invention.

FIG. 14 is a diagram schematically illustrating a synthetic instance that is generated by a technique disclosed in Non-patent Literature 1.

FIG. 15 is a block diagram illustrating a configuration of a computer that functions as the information processing apparatuses in accordance with the first through fifth example embodiments of the present invention.

### EXAMPLE EMBODIMENTS

### First Example Embodiment

The following description will discuss a first example embodiment of the present invention in detail, with reference to the drawings. The present example embodiment is a basic form of example embodiments described later.

### <Configuration of Information Processing Apparatus>

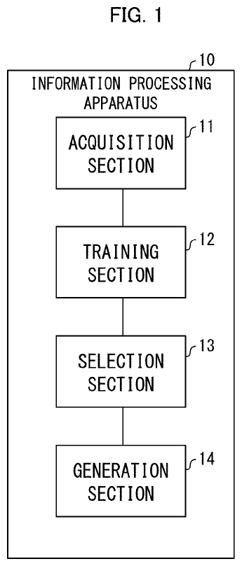

The following description will discuss a configuration of an information processing apparatus 10 in accordance with the present example embodiment, with reference to FIG. 1. FIG. 1 is a block diagram illustrating the configuration of the information processing apparatus 10. The information processing apparatus 10 is an apparatus which generates a synthetic instance from a plurality of training instances using a machine learning model group.

As illustrated in FIG. 1, the information processing apparatus 10 includes an acquisition section 11, a training section 12, a selection section 13, and a generation section 14. The acquisition section 11 is an example configuration for realizing the acquisition means recited in claims. The training section 12 is an example configuration for realizing the training means recited in claims. The selection section 13 is an example configuration for realizing the selection means recited in claims. The generation section 14 is an example configuration for realizing the generation means recited in claims.

The acquisition section 11 acquires a plurality of training instances. The training section 12 trains, with use of a plurality of training instances, a machine learning model group that includes a plurality of machine learning models each of which outputs a prediction result while using instances as input. The selection section 13 selects, among the plurality of training instances, a training instance which derives variation in a plurality of prediction results obtained by using the machine learning model group which has been trained. The generation section 14 generates a synthetic instance by combining, among the plurality of training instances, two or more training instances including the training instance which has been selected.

### (Machine Learning Model Group)

The machine learning model group includes a plurality of machine learning models. Each of the plurality of machine learning models outputs a prediction result while using instances as input. The prediction result may include, for example, a prediction probability that each of a plurality of labels would be predicted. In this case, a label with the highest prediction probability may be referred to as the prediction result. The machine learning model is, for example, a model generated using a machine learning algorithm such as a decision tree, a neural network, a random forest, or a support vector machine. Note, however, that the machine learning algorithm used in generating each machine learning model is not limited to these. The plurality of machine learning models may be models which are all generated using a single machine learning algorithm. Alternatively, it is possible that at least two machine learning models included in the plurality of machine learning models are generated using machine learning algorithms which are different from each other. The machine learning model group may be, for example, stored in a memory of the information processing apparatus 10 or stored in another apparatus which is communicably connected to the information processing apparatus 10.

Moreover, the plurality of machine learning models in the machine learning model group do not all necessarily need to be “a machine learning model to be trained using a generated synthetic instance”. In other words, the machine learning model group may include at least one of or all of machine learning models to be trained. The machine learning model group does not need to include a machine learning model to be trained. The number of machine learning models to be trained may be two or more or may be one.

### (Instance, Training Instance, Synthetic Instance)

An instance is information input into each machine learning model, and includes a feature quantity. In other words, the instance is present in a feature quantity space. The training instance is an instance used in training of a machine learning model group. The training instance may be an instance obtained by observation or may be a synthetic instance that has been synthetically generated.

(Training Instance which Derives Variation in Prediction Results)

A training instance which derives variation in a plurality of prediction results is a training instance for which a result of variation evaluation indicates that “variation is large”. For example, evaluation of variation is to evaluate whether or not variation in a plurality of prediction results is large. As a specific example, the evaluation of variation may be evaluation based on vote entropy. The vote entropy will be described later in detail in the second example embodiment. The evaluation of variation may be evaluation based on a proportion of prediction results that indicate the same label among a plurality of prediction results. Note, however, that the evaluation of variation is not limited to those described above. Hereinafter, a “training instance that has been evaluated to derive large variation in a plurality of prediction results” is also referred to as a “training instance which derives variation in prediction results”. Moreover, a “training instance that has been evaluated not to derive large variation in a plurality of prediction results” is also referred to as a “training instance which derives small variation in prediction results”.

### <Flow of Information Processing Method>

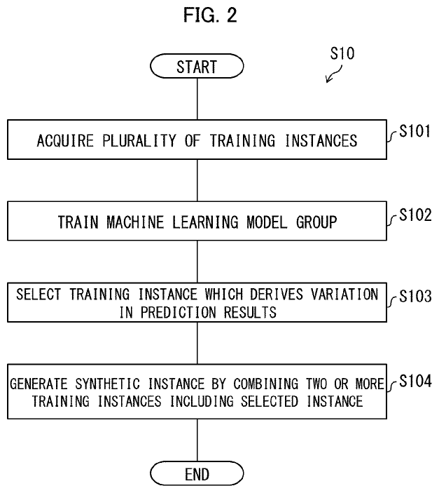

The following description will discuss a flow of an information processing method S10 in accordance with the present example embodiment, with reference to FIG. 2. FIG. 2 is a flowchart illustrating the flow of the information processing method S10. As illustrated in FIG. 2, the information processing method S10 includes steps S101 through S104.

### (Step S101)

In step S101 (acquisition process), the acquisition section 11 acquires a plurality of training instances. For example, the acquisition section 11 may acquire a plurality of training instances by reading those from a memory. Alternatively, for example, the acquisition section 11 may acquire a plurality of training instances from an input apparatus or may acquire a plurality of training instances from an apparatus which is connected via a network. The plurality of training instances acquired in this step include one or both of an observation instance and a synthetic instance.

### (Step S102)

In step S102 (training process), the training section 12 trains a machine learning model group with use of the plurality of training instances which have been acquired in step S101. Here, a training instance to be used in training each model in the machine learning model group may be at least one of or all of the plurality of training instances which have been acquired in step S101.

### (Step S103)

In step S103 (selection process), the selection section 13 selects, among the plurality of training instances, a training instance which derives variation in prediction results. The selection section 13 may select one of such training instances or may select a plurality of such training instances.

Specifically, the selection section 13 inputs, among the plurality of training instances, a training instance to be evaluated into each of the machine learning models which has been trained, and acquires a prediction result which is output from each of the machine learning models. Thus, the selection section 13 obtains a plurality of prediction results for the training instance to be evaluated. Moreover, the selection section 13 evaluates variation in the plurality of prediction results obtained. In a case where the selection section 13 has evaluated that variation in the plurality of prediction results is large, the selection section 13 selects the training instance of interest as a “training instance which derives variation in prediction results”.

Note that the selection section 13 sets at least one of or all of the plurality of training instances as a target(s) for evaluation of variation. For example, in a case where each model in the machine learning model group has been trained using at least one of the plurality of training instances, the selection section 13 may set the other ones of the plurality of training instances (i.e., training instances that have not been used in training of the machine learning model group) as evaluation targets, respectively.

### (Step S104)

In step S104 (generation process), the generation section 14 generates a synthetic instance by combining, among the plurality of training instances, two or more training instances including the training instance which has been selected in step S103. For example, the generation section 14 may combine the training instance which has been selected and another training instance which is present, in the feature quantity space, near the selected training instance. Alternatively, for example, in a case where a plurality of training instances have been selected in step S103, the generation section 14 may combine the plurality of training instances which have been selected. The generation section 14 may generate a single synthetic instance by combining two training instances or may generate a single synthetic instance by combining three or more training instances. The generation section 14 may generate a single synthetic instance or may generate a plurality of synthetic instances in this step.

### Specific Example of Combining Process

In a case where two training instances are combined to generate a single synthetic instance, the combining process carried out by the generation section 14 is expressed, for example, by the following formula (1).

$${\hat{x}}_{v} = λ {x}_{i} + ( 1 - λ ) {x}_{j} \qquad ( 1 )$$

In formula (1), \hat{ }xᵥ represents a synthetic instance, and xᵢ represents a training instance which has been selected by the selection section 13. xⱼ can be another training instance which has been selected by the selection section 13 or can be another training instance which has not been selected. In a case of another training instance which has not been selected, xⱼ is a training instance which is present near xᵢ. A is a weight coefficient that satisfies 0≤λ≤1. The generation section 14 decides, for example, a value of the coefficient A using a random number which has been generated by a random function. Note that the combining process carried out by the generation section 14 is not limited to the above-described technique, and the generation section 14 may combine a plurality of training instances by another technique.

### Specific Example of Information Processing Method

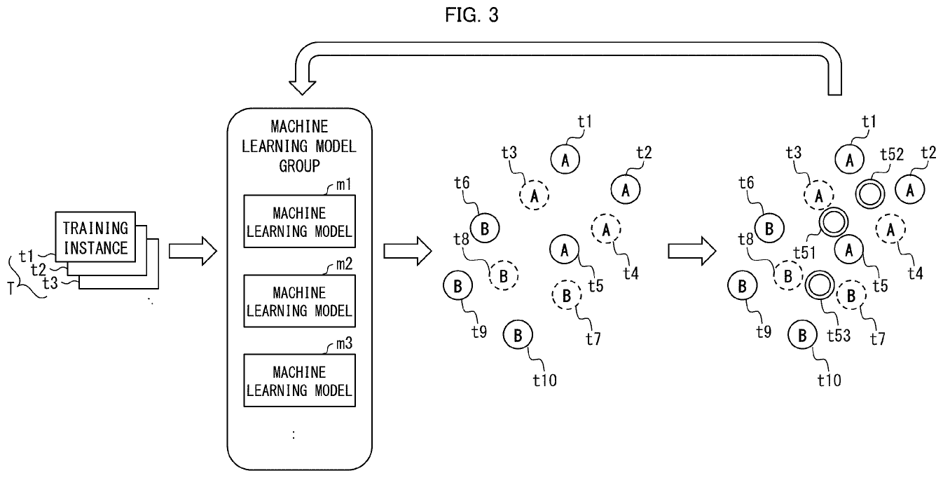

The following description will discuss a specific example of the information processing method S10, with reference to FIG. 3. FIG. 3 is a diagram schematically illustrating a specific example of the information processing method S10.

In the present specific example, a plurality of training instances T which are acquired by the acquisition section 11 in step S101 include training instances t1, t2, t3, and so forth. The machine learning model group which is trained by the training section 12 in step S102 includes machine learning models m1, m2, m3, and so forth. Each of the machine learning models m1, m2, m3, and so forth outputs one of labels “A” and “B” as a prediction result, upon input of an instance. Each of the machine learning models m1, m2, m3, and so forth is trained using at least one of or all of the training instances T. In step S103, the selection section 13 evaluates variation in a plurality of prediction results for training instances t1 through t10 to be evaluated. In FIG. 3, a circle drawn by the solid line indicates a training instance which derives variation in prediction results, and a circle drawn by the dashed line indicates a training instance which derives small variation in prediction results.

Specifically, the training instances t1, t2, and t5 all derive “A” as a plurality of prediction results obtained from the machine learning models m1, m2, m3, and so forth, and in this example, it is evaluated that variation in prediction results is not large. The training instances t6, t9, and t10 all derive “B” as a plurality of prediction results obtained from the machine learning models m1, m2, m3, and so forth, and in this example, it is evaluated that variation in prediction results is not large. For the training instances t3 and t4, two of a plurality of prediction results obtained from the machine learning models m1, m2, m3, and so forth indicate “A” and one of the plurality of prediction results indicates “B”. In this example, it is evaluated that variation in prediction results is large. For the training instances t7 and t8, two of a plurality of prediction results obtained from the machine learning models m1, m2, m3, and so forth indicate “B” and one of the plurality of prediction results indicates “A”. In this example, it is evaluated that variation in prediction results is large.

Therefore, the selection section 13 selects training instances t3, t4, t7, and t8 each of which derives variation in prediction results. In step S104, the generation section 14 generates a synthetic instance t51 by combining the training instance t3 which derives variation in prediction results and the training instance t5 near that training instance t3. Moreover, the generation section 14 generates a synthetic instance t52 by combining the training instance t4 which derives variation in prediction results and the training instance t1 near that training instance t4. Moreover, the generation section 14 generates a synthetic instance t53 by combining the training instances t7 and t8 each of which derives variation in a plurality of prediction results. In FIG. 3, a circle drawn by the double line indicates a synthetic instance.

### Example Advantage of Present Example Embodiment

The present example embodiment employs the configuration of including: acquiring a plurality of training instances; training, with use of the plurality of training instances, a machine learning model group that includes a plurality of machine learning models each of which outputs a prediction result while using instances as input; selecting, among the plurality of training instances, a training instance which derives variation in a plurality of prediction results obtained by using the machine learning model group which has been trained; and generating a synthetic instance by combining, among the plurality of training instances, two or more training instances including the training instance which has been selected.

Here, the training instance which derives variation in a plurality of prediction results is considered to be present in a region which is short of a training instance in a feature quantity space. It is highly likely that a synthetic instance obtained by combining a plurality of training instances including such a training instance is generated in a region which is short of a training instance. Therefore, the present example embodiment can generate a synthetic instance in a region which is short of a training instance.

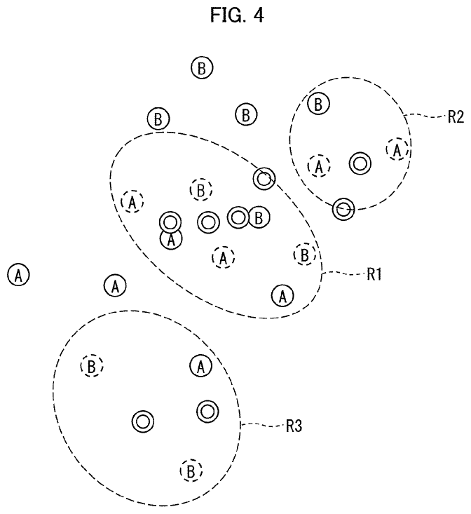

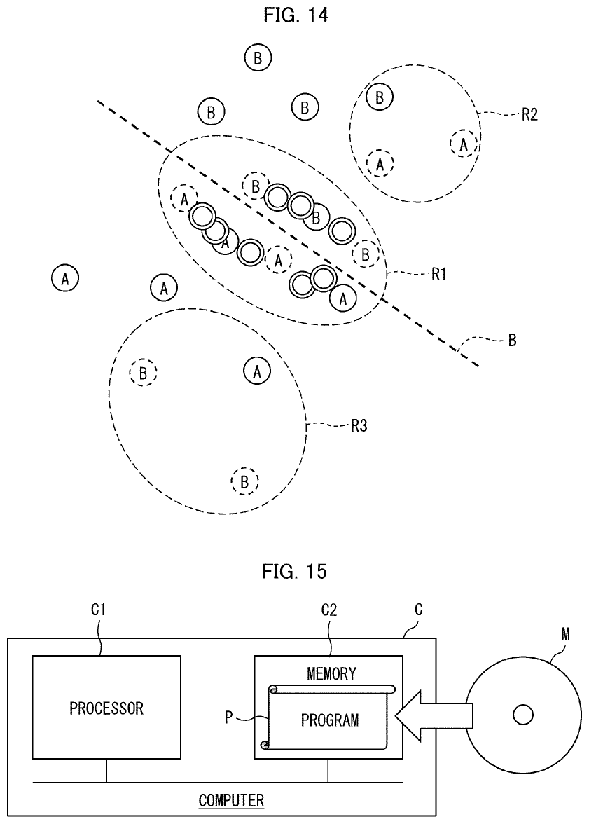

The following description will discuss an example advantage of the present example embodiment, with reference to FIG. 4 and FIG. 14. FIG. 4 is a diagram schematically illustrating a synthetic instance that is generated in the present example embodiment. FIG. 14 is a diagram schematically illustrating a synthetic instance that is generated by a technique disclosed in Non-patent Literature 1. In FIG. 4 and FIG. 14, a circle drawn by the solid line indicates a training instance which derives small variation in prediction results, a circle drawn by the dashed line indicates a training instance which derives variation in prediction results, and a circle drawn by the double line indicates a synthetic instance. Regions R1, R2, and R3 indicate regions in a feature quantity space. The regions R1, R2, and R3 each include a synthetic instance which derives variation in prediction results, and are short of synthetic instances.

As illustrated in FIG. 14, the technique disclosed in Non-patent Literature 1 generates a synthetic instance in a region R1 that is near a decision boundary B by a support vector machine. However, it is difficult for the technique disclosed in Non-patent Literature 1 to generate synthetic instances in regions R2 and R3 which are short of training instances and which are not near the decision boundary B.

In contrast, as illustrated in FIG. 4, the present example embodiment generates a synthetic instance by combining a plurality of training instances including a training instance which derives variation in prediction results. Therefore, the present example embodiment makes it possible to generate synthetic instances in the regions R1, R2, and R3 which are short of training instances. Moreover, the present example embodiment makes it possible to suppress generation of synthetic instances more in a part of regions, i.e., more in the region R1.

Moreover, the present example embodiment employs the configuration of using a machine learning model group in order to select a training instance which derives variation in prediction results.

Therefore, the present example embodiment makes it possible to suppress generation of synthetic instances more in a certain region, as compared with a case where synthetic instances are generated near a decision boundary as in the technique disclosed in Non-patent Literature 1.

Moreover, with the above configuration, the present example embodiment makes it possible to generate a synthetic instance in a region which is more short of a training instance, as compared with a case of using a prediction probability to select a training instance which derives variation in prediction results. This is because, for example, in a case where a decision tree is included in the machine learning model group, the decision tree may make a wrong prediction with a prediction probability of 1.

### Second Example Embodiment

The following description will discuss a second example embodiment of the present invention in detail with reference to the drawings. The same reference numerals are given to constituent elements which have functions identical with those described in the first example embodiment, and descriptions as to such constituent elements are omitted as appropriate.

### <Configuration of Information Processing Apparatus>

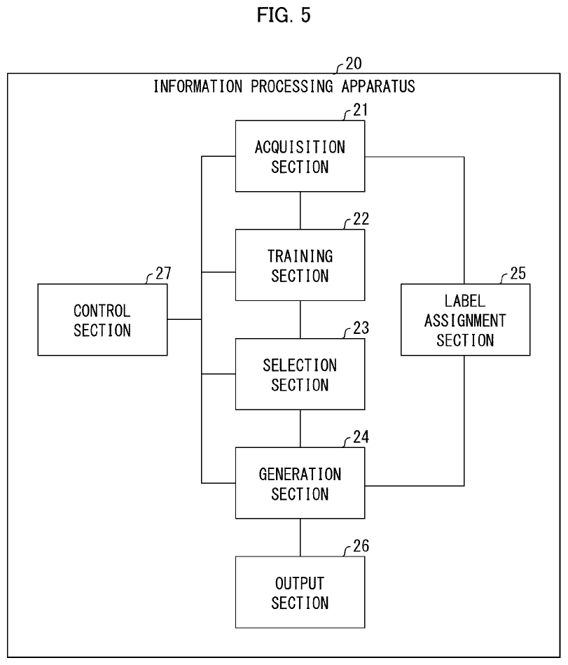

The following description will discuss a configuration of an information processing apparatus 20 in accordance with the present example embodiment, with reference to FIG. 5. FIG. 5 is a block diagram illustrating the configuration of the information processing apparatus 20. The information processing apparatus 20 is an apparatus which generates a synthetic instance from a plurality of instances using a machine learning model group COM0.

### (Machine Learning Model Group)

The machine learning model group COM0 is configured in a manner substantially similar to the machine learning model group in the first example embodiment. Note, however, that, in the present embodiment, among the plurality of machine learning models included in the machine learning model group COM0, at least two machine learning models are generated using machine learning algorithms which are different from each other.

Moreover, the machine learning model group COM0 includes a machine learning model which is to be trained using a synthetic instance. Moreover, at least one machine learning model included in the machine learning model group COM0 is a decision tree. Here, the machine learning model to be trained is a decision tree.

As illustrated in FIG. 5, the information processing apparatus 20 includes an acquisition section 21, a training section 22, a selection section 23, a generation section 24, a label assignment section 25, an output section 26, and a control section 27. The acquisition section 21 is an example configuration for realizing the acquisition means recited in claims. The training section 22 is an example configuration for realizing the training means recited in claims. The selection section 23 is an example configuration for realizing the selection means recited in claims. The generation section 24 is an example configuration for realizing the generation means recited in claims. The label assignment section 25 is an example configuration for realizing the label assignment means recited in claims. The output section 26 is an example configuration for realizing the output means recited in claims.

The acquisition section 21 is configured in a manner similar to the acquisition section 11 in the first example embodiment.

The training section 22 is configured in a manner substantially similar to the training section 12 in the first example embodiment, except that training is carried out while dividing the machine learning model group COM0 into a plurality of groups. Details of the training process by the training section 22 will be described later.

The selection section 23 is configured in a manner substantially similar to the selection section 23 in the first example embodiment. However, details of a training instance that is to be evaluated for variation in prediction results are different. The details of the training instance to be evaluated will be described later.

The generation section 24 generates a synthetic instance by combining a training instance which has been selected by the selection section 23 and an instance which is present, in a feature quantity space, near the selected training instance. For example, the generation section 24 generates a synthetic instance by combining two training instances according to formula (1) described above.

The label assignment section 25 assigns a label(s) to at least one of or all of the plurality of training instances and the synthetic instance. The label assignment section 25 may assign a label based on, for example, information output from an input apparatus which receives a user operation. Alternatively, for example, the label assignment section 25 may assign a label obtained by inputting a training instance and a synthetic instance into a machine learning model which has been trained to output a label while using instances as input. In this case, the machine learning model that outputs a label is a machine learning model which is different from each of the machine learning models included in the machine learning model group COM0. Moreover, it is preferable that the machine learning model for outputting a label is a model having higher prediction accuracy than at least one machine learning model included in the machine learning model group. For example, in a case where a machine learning model to be trained included in the machine learning model group is a decision tree, the machine learning model that outputs a label may be a random forest.

The output section 26 outputs a synthetic instance generated by the generation section 24. The output section 26 may, for example, cause a storage medium such as an external storage apparatus to store the synthetic instance generated by the generation section 24. The output section 26 may output the synthetic instance to an output apparatus such as a display apparatus, for example.

The control section 27 controls each section of the information processing apparatus 20. In the present example embodiment, in particular, the control section 27 adds the synthetic instance generated by the generation section 24 to the plurality of training instances, and causes the acquisition section 21, the training section 22, the selection section 23, and the generation section 24 to function again.

### <Flow of Information Processing Method>

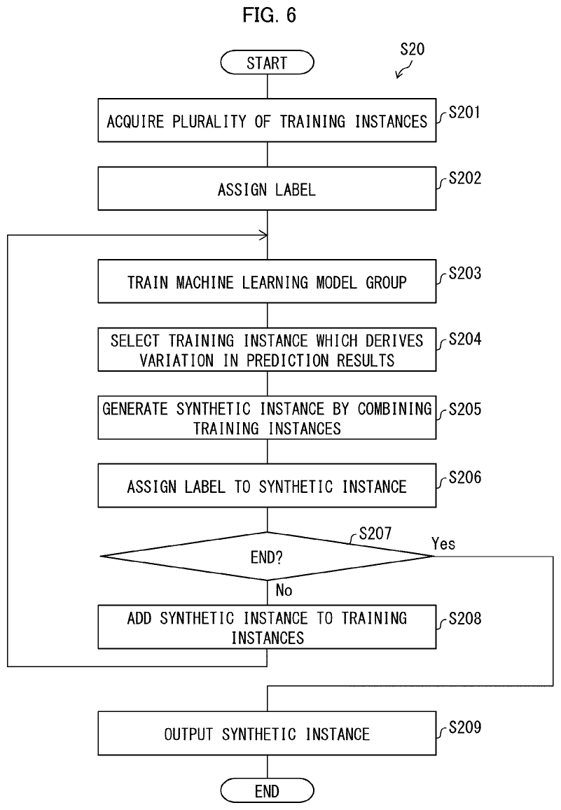

The following description will discuss a flow of an information processing method S20 in accordance with the present example embodiment, with reference to FIG. 6. FIG. 6 is a flowchart illustrating the flow of the information processing method S20.

### (Step S201)

In step S201 (acquisition process), the acquisition section 11 acquires a plurality of training instances. The plurality of training instances to be acquired may include instances obtained by observation or may include a synthetic instance.

### (Step S202)

In step S202, the label assignment section 25 assigns a label to each of the plurality of training instances which have been acquired by the acquisition section 21.

### (Step S203)

In step S203 (training process), the training section 22 trains each of the plurality of machine learning model groups with use of at least one of or all of the plurality of training instances which have been acquired by the acquisition section 21. Details of a training process of training each of the machine learning model groups will be described later.

### (Step S204)

In step S204 (selection process), the selection section 23 selects, among the plurality of training instances which have been acquired by the acquisition section 21, one or more training instances each of which derives variation in prediction results. The selection process carried out by the selection section 23 will be described later. Details of the process of selecting a training instance which derives variation in prediction results will be described later.

### (Step S205)

In step S205 (generation process), the generation section 24 identifies, as subjects to be combined, a plurality of training instances including the training instance which has been selected by the selection section 23. Moreover, the generation section 24 generates a synthetic instance by combining the plurality of training instances which have been identified as subjects to be combined. Details of the generation process carried out by the generation section 24 will be described later.

### (Step S206)

In step S206, the label assignment section 25 assigns a label to each of the synthetic instances generated by the generation section 24. In step S207, the control section 27 determines whether or not to end the training process. For example, in a case where the number of times of carrying out the processes of steps S203 through S206 is equal to or more than a predetermined threshold, the control section 27 determines to end the training process. Meanwhile, in a case where the number of times of carrying out the processes of steps S203 through S206 is less than the predetermined threshold, the control section 27 determines not to end the training process. In a case where the training process does not end (NO in step S207), the control section 27 proceeds to a process of step S208. Meanwhile, in a case where the training process ends (YES in step S207), the control section 27 proceeds to a process of step S209.

### (Step S208)

In step S208, the control section 27 adds, to the plurality of training instances, one or more synthetic instances which have been generated in step S206 carried out so far. After completion of the process of step S208, the control section 27 returns to the process of step S203. In other words, the control section 27 adds the synthetic instance to the plurality of training instances, and causes the acquisition section 21, the training section 22, the selection section 23, and the generation section 24 to function again.

### (Step S209)

In step S209, the output section 26 outputs one or more synthetic instances which have been generated in step S206 carried out so far.

### <Training of Machine Learning Model to be Trained>

The One or More Synthetic Instances Thus Generated using the information processing method S20 are used to train a machine learning model to be trained. The process of training the machine learning model to be trained may be carried out by the training section 22, for example.

### Specific Example of Training Process and Selection Process

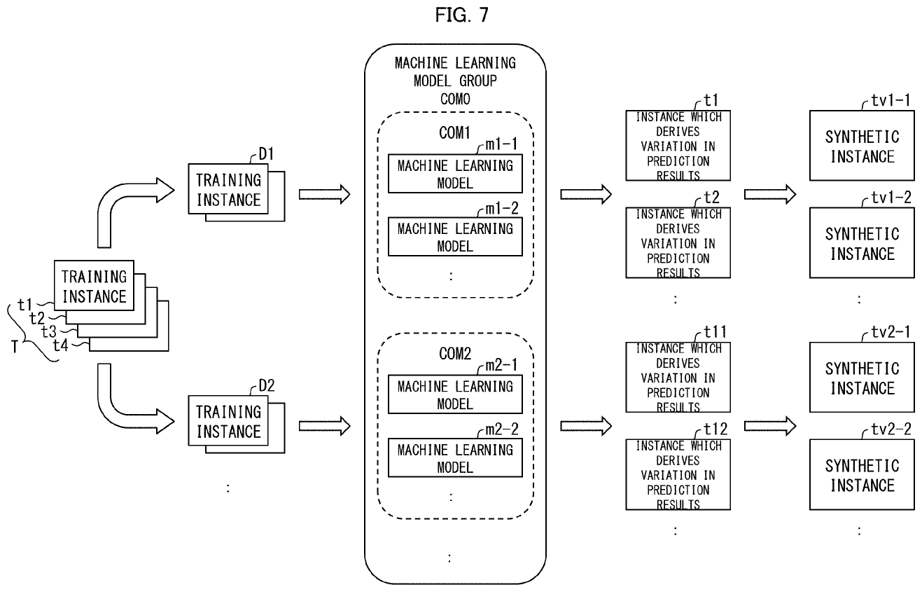

The following description will discuss a specific example of the training process and the selection process in steps S203 and S204, with reference to FIG. 7. FIG. 7 is a diagram schematically illustrating a specific example of the information processing method S20.

As illustrated in FIG. 7, in step S203, the training section 22 carries out training while dividing the machine learning model group COM0 into a plurality of groups COMi (i=1, 2, . . . , M; M is an integer of 2 or more). Hereinafter, each of the divided groups is referred to as a machine learning model group COMi. The machine learning model group COMi includes a plurality of machine learning models mi-j (j=1, 2, and so forth). Hereinafter, the plurality of machine learning models included in the machine learning model group COMi are referred to as machine learning models mi-j. The plurality of machine learning models mi-j included in the machine learning model group COMi can be models all generated by a single machine learning algorithm, or can be models at least two of which are generated by machine learning algorithms which are different from each other. The number of machine learning models mi1-j included in a machine learning model group COMi1 may be identical with or different from the number of machine learning models mi2-j included in a machine learning model group COMi2 (i1=1, 2, . . . , M; i2=1, 2, . . . , M; i1≠i2).

In step S203, the training section 22 extracts a training instance group Di from a training instance group T which has been acquired by the acquisition section 21 in step S201. The training instance group Di is a part of the training instance group T. For example, the training section 22 may extract the training instance group Di by random sampling. Training instances included in a training instance group Di1 may be all identical with, or partially different from, or entirely different from training instances included in a training instance group Di2. The training section 22 repeats, for i=1, 2, . . . , M, training of each of the machine learning models mi-j included in the machine learning model group COMi with use of the training instance group Di.

In step S204, the selection section 23 repeats, for i=1, 2, . . . , M, selecting, with use of the machine learning model group COMi, a training instance which derives variation in prediction results. Specifically, the selection section 23 evaluates variation in prediction results for each of training instances (i.e., training instances other than the training instance group Di among the training instance group T) which have not been used in training of the machine learning model group COMi. Thus, the selection section 23 selects, among such training instances to be evaluated, a training instance which derives variation in prediction results. In the example illustrated in FIG. 7, the selection section 23 selects, with use of a machine learning model group COM1, training instances t1, t2, and so forth each of which derives variation in prediction results. Moreover, the selection section 23 selects, with use of a machine learning model group COM2, training instances t11, t12, and so forth each of which derives variation in prediction results.

For example, the selection section 23 carries out evaluation of variation for each training instance to be evaluated, with use of an index of vote entropy in a technique of query by committee (QBC). For example, formula (2) below is an expression indicating a training instance \hat{ }x in which vote entropy is maximum.

$$\hat{x} = {argmax}_{x} ( - {\sum }_{y} \frac{V ( y )}{C} log \frac{V ( y )}{C} ) \qquad ( 2 )$$

In formula (2), C represents a total number of machine learning models mi-j in the machine learning model group COMi. V(y) represents the number of machine learning models mi-j each of which has predicted a label y in the machine learning model group COMi. The selection section 23 may select the training instance \hat{ }x, which is indicated by formula (2), as a training instance which derives variation in prediction results. In this case, the selection section 23 selects, for each machine learning model group COMi, one training instance which derives variation in prediction results. In other words, in this case, the selection section 23 selects M training instances each of which derives variation in prediction results, using M machine learning model groups COMi. Alternatively, the selection section 23 may select, for each machine learning model group COMi, a predetermined number of training instances in order of decreasing vote entropy, or a training instance(s) with vote entropy which is equal to or greater than a threshold. In this case, the selection section 23 may select, for each machine learning model group COMi, a plurality of training instances each of which derives variation in prediction results. In other words, in this case, the selection section 23 selects M or more training instances each of which derives variation in prediction results, using M machine learning model groups COMi. Furthermore, the selection section 23 may select one training instance or a predetermined number of training instances randomly from M or more training instances each of which has variation in prediction results and which have been selected as described above. Alternatively, the selection section 23 may select one training instance or a predetermined number of training instances in order of decreasing vote entropy.

### Specific Example of Generation Process

The following description will discuss a specific example of the generation process in step S205. In step S205, the generation section 24 carries out, with use of a training instance which derives variation in prediction results, one of a first generation process S30, a second generation process S40, and a third generation process S50 to generate a synthetic instance. The first generation process S30 is a process of generating a synthetic instance by combining a training instance which derives variation in prediction results and a training instance near that training instance. The second generation process is a process of generating a synthetic instance by combining two or more training instances each of which derives variation in prediction results. The third generation process is a process of selectively carrying out one of the first generation process and the second generation process.

### (First Generation Process)

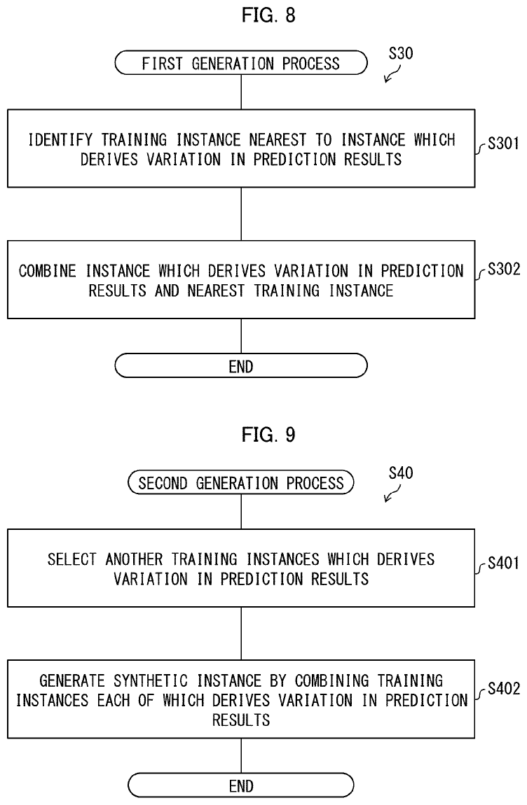

The following description will discuss the first generation process S30, with reference to FIG. 8. FIG. 8 is a flowchart illustrating a flow of the first generation process S30. In FIG. 8, the first generation process S30 includes steps S301 and S302. Here, in step S204 which has been antecedently carried out, one or more training instances each of which derives variation in prediction results are selected. The generation section 24 carries out steps S301 and S302 below for each of the one or more training instances (hereinafter, referred to as a training instance of interest) each of which derives variation in prediction results.

### (Step S301)

In step S301, the generation section 24 selects a training instance which is near the training instance of interest. The near training instance may be a training instance which derives variation in prediction results or may be a training instance which derives small variation in prediction results. For example, the near training instance may be a training instance that is, among a training instance group T, nearest in distance to the training instance of interest in a feature quantity space. Alternatively, for example, the near training instance may be a training instance that is, among the training instance group T, apart from the training instance of interest in the feature quantity space by a distance that is equal to or less than a threshold.

### (Step S302)

In step S302, the generation section 24 generates a synthetic instance by combining the training instance of interest and the near training instance which has been selected in step S301. For example, in the example illustrated in FIG. 7, a synthetic instance tv1-1 is generated by combining a training instance t1 that derives variation in prediction results and a training instance near the training instance t1. Moreover, a synthetic instance tv1-2 is generated by combining a training instance t2 which derives variation in prediction results and a training instance near the training instance t2.

Here, as an example of the combining process, the generation section 24 may use formula (1) described above. Alternatively, as another example of the combining process, the generation section 24 may use a known technique such as MUNGE (see Reference Literature 1) or SMOTE (see Reference Literature 2).
[Reference Literature 1] Bucilua, C., Caruana, R. and Niculescu-Mizil, A., “Model Compression”, Proc. ACM SIGKDD, pp. 535-541 (2006)
[Reference Literature 2] Chawla, N. V., Bowyer, K. W., Hall, L. O., and Kegelmeyer, W. P., “SMOTE: Synthetic minority over-sampling technique”, Journal of Artificial Intelligent Research, 16, 321-357 (2002).

### (Second Generation Process)

The following description will discuss the second generation process S40, with reference to FIG. 9. FIG. 9 is a flowchart illustrating a flow of the second generation process S40. As illustrated in FIG. 9, the second generation process S40 includes steps S401 and S402. Note that the second generation process can be carried out in a case where a plurality of training instances each of which derives variation in prediction results are selected in step S204. The generation section 24 carries out steps S401 and S402 below for each of the plurality of training instances (hereinafter, referred to as a training instance of interest) each of which derives variation in prediction results.

### (Step S401)

In step S401, the selection section 23 selects, among the plurality of training instances each of which derives variation in prediction results, another training instance that is different from the training instance of interest. In other words, the selection section 23 selects, among the plurality of training instances, two or more training instances each of which derives variation in a plurality of prediction results. For example, the selection section 23 may select such another training instance randomly from the plurality of training instances each of which derives variation in prediction results. Alternatively, for example, the selection section 23 may select, as such another training instance, a training instance that is nearest in distance to the training instance of interest or a training instance that is apart from the training instance of interest by a distance equal to or less than a threshold in the feature quantity space, among the plurality of training instances each of which derives variation in prediction results. In a case where the training instance of interest has already been used in combining, the processes of steps S401 and S402 do not need to be carried out for the training instance of interest.

### (Step S402)

In step S402, the generation section 24 generates a synthetic instance by combining the training instance of interest and the another training instance which has been selected in step S401. For example, in the example illustrated in FIG. 7, a synthetic instance tv2-1 is generated by combining training instances t11 and t12 each of which derives variation in prediction results. Here, the two or more training instances which are combined together by the generation section 24 may be selected using a single machine learning model group COMi as in this example, or at least one of the two or more training instances may be selected using a machine learning model group COMi which is different from that for the other training instance(s). For example, in the example illustrated in FIG. 7, the generation section 24 may select two or more training instances from training instances t1, t2, . . . , t11, t12, and so forth each of which derives variation in prediction results, and combine the selected training instances to generate a synthetic instance tv1-1, tv1-2, tv2-1, or tv2-2. Note that a technique used in the combining process in step S402 is as described in step S302, and therefore the detailed description thereof will not be repeated here.

### (Third Generation Process)

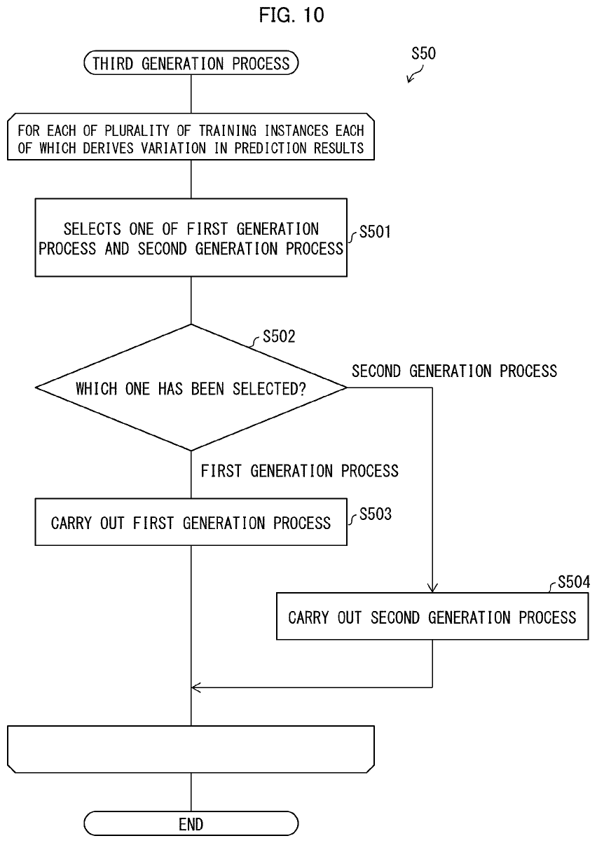

The following description will discuss the third generation process, with reference to FIG. 10. FIG. 10 is a flowchart illustrating a flow of the third generation process S50. In FIG. 10, the third generation process S50 includes steps S501 through S503. Here, in step S204, one or more training instances each of which derives variation in prediction results have been selected. The generation section 24 carries out steps S501 through S503 below for each of the one or more training instances (hereinafter, referred to as a training instance of interest) each of which derives variation in prediction results.

### (Step S501)

In step S501, the generation section 24 selects one of the first generation process and the second generation process. For example, it is possible that the generation section 24 selects the first generation process using a probability p which has been decided by a random function, or selects the second generation process if the first generation process has not been selected. Note that a technique for selecting one of the first generation process and the second generation process is not limited to the technique of using the probability p, and may be another technique.

(Steps S502 through S504)

In step S502, the generation section 24 determines which one of the first and second generation processes has been selected. In a case where the first generation process has been selected, the generation section 24 proceeds to a process of step S503, and carries out the first generation process. Meanwhile, in a case where the second generation process has been selected, the generation section 24 proceeds to a process of step S504, and carries out the second generation process. Details of the first generation process and the second generation process are as described above.

### Example Advantage of Present Example Embodiment

The present example embodiment has the configuration of carrying out the first generation process of generating a synthetic instance by combining a training instance which derives variation in prediction results and a training instance near that training instance.

Here, the synthetic instance generated in the first generation process is generated near the training instance which derives variation in prediction results. The training instance which derives variation in prediction results is considered to be a region which is short of a training instance in a feature quantity space. Therefore, such a synthetic instance is generated in a region which is short of a training instance.

Moreover, the present example embodiment has the configuration of carrying out the second generation process of generating a synthetic instance by combining two or more training instances each of which derives variation in prediction results.

Here, the synthetic instance generated in the second generation process is obtained by combining training instances in a region which is short of a training instance. Therefore, it is highly likely that a region in which such a synthetic instance is present is also short of a training instance.

Moreover, the present example embodiment has the configuration of carrying out the third generation process of generating a synthetic instance by selecting and carrying out one of the first generation process and the second generation process.

Here, for example, the synthetic instance generated in the third generation process is generated by the first generation process or the second generation process. A region in which a synthetic instance is generated by the first generation process can differ from a region in which a synthetic instance is generated by the second generation process. Therefore, in a case where a plurality of synthetic instances are generated by the third generation process, it is highly likely that those synthetic instances are generated to distribute to more various regions which are short of training instances.

As a result, by carrying out one of the first generation process, the second generation process, and the third generation process, the present example embodiment makes it possible to generate a synthetic instance in a region which is more short of a training instance, without excessively generating synthetic instances more in a region having sufficient training instances.

Moreover, in the present example embodiment, the machine learning model group includes a machine learning model to be trained. Therefore, the present example embodiment makes it possible to generate an effective synthetic instance by improvement in accuracy of the machine learning model to be trained.

Moreover, the present example embodiment employs the configuration in which at least two machine learning models included in the machine learning model group are generated by machine learning algorithms which are different from each other.

This makes it possible to select, with higher accuracy, a training instance which derives variation in prediction results.

In the present example embodiment, the machine learning model to be trained is a decision tree, and is not a support vector machine. In the present example embodiment, such a machine learning model to be trained is included in the machine learning model group COM0. Therefore, the present example embodiment makes it possible to generate an effective synthetic instance by improvement in accuracy of the machine learning model to be trained, as compared with the technique disclosed in Non-patent Literature 1 in which a synthetic instance is generated near the decision boundary of the support vector machine.

### Third Example Embodiment

The following description will discuss a third example embodiment of the present invention in detail with reference to the drawings. The same reference numerals are given to constituent elements which have functions identical with those described in the second example embodiment, and descriptions as to such constituent elements are not repeated. The present example embodiment is an example embodiment obtained by altering the generation section 24 in the second example embodiment as follows.

### <Configuration of Generation Section>

In the present example embodiment, the generation section 24 generates a plurality of synthetic instances. Moreover, among the plurality of synthetic instances which have been generated, the generation section 24 integrates, into a single synthetic instance, two synthetic instances that satisfy a similarity condition. Here, the similarity condition is a condition indicating that instances are similar to each other. The similarity condition may be, for example, that a cosine similarity is equal to or greater than a threshold, or that a distance in a feature quantity space is equal to or less than a threshold. Note, however, that the similarity condition is not limited to these. Details of the integration process will be described later.

### <Flow of Information Processing Method>

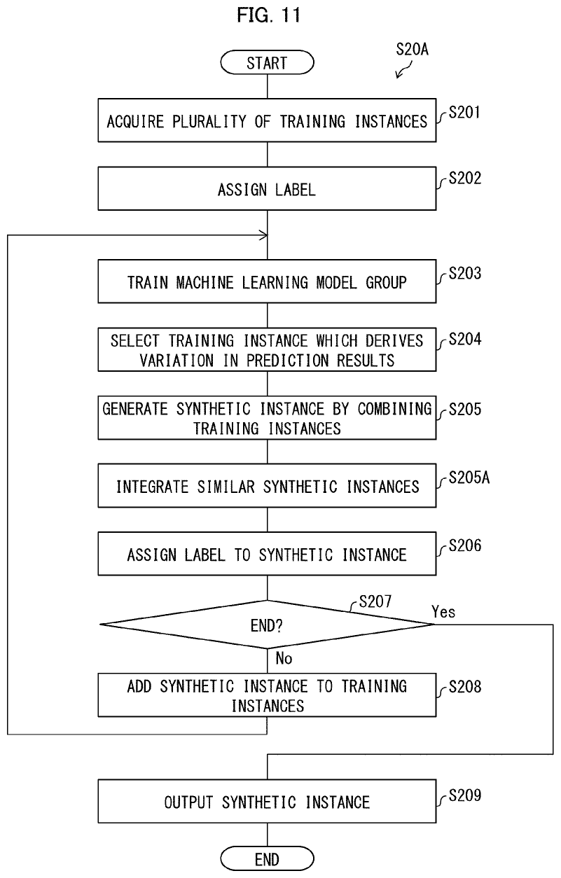

The following description will discuss an information processing method S20A in the present example embodiment, with reference to FIG. 11. FIG. 11 is a flowchart illustrating a flow of the information processing method S20A in accordance with the third example embodiment. The information processing method S20A illustrated in FIG. 11 is configured in a manner substantially similar to the information processing method S20 in accordance with the second example embodiment, except for a feature of further including step S205A.

### (Step S205A)

In step S205A, the generation section 24 integrates two similar synthetic instances among synthetic instances generated in step S205. Specifically, the generation section 24 determines whether or not a synthetic instance generated in step S205 this time and any of synthetic instances generated in step S205 at and before the previous time satisfy the similarity condition. In a case where it has been determined that the similarity condition is satisfied, the generation section 24 integrates two synthetic instances that satisfy the similarity condition.

### Specific Example of Integration Process

Examples of the integration process include a process of combining two synthetic instances. In this case, the generation section 24 generates a single synthetic instance by combining the two synthetic instances, and deletes the original two synthetic instances which satisfy the similarity condition. Another example of the integration process is a process of deleting one of the two synthetic instances. Note that the integration process only needs to be a process of employing, instead of two synthetic instances that satisfy the similarity condition, a single synthetic instance that has been generated with reference to the two synthetic instances of interest, and is not limited to the above-described process. Note that deleting a synthetic instance is to remove the synthetic instance from subjects to each of which a label is to be assigned in step S206 and from subjects to be added to training instances in step S208. As such, a label is assigned to the integrated synthetic instance, and the integrated synthetic instance is added to training instances.

### Example Advantage of Present Example Embodiment

In the present example embodiment, the configuration is employed in which the generation section generates a plurality of synthetic instances and integrates, into a single synthetic instance, two synthetic instances that satisfy a similarity condition among the plurality of synthetic instances which have been generated.

Here, in a case where a plurality of instances present in a region which is short of a training instance are similar to each other, it is not efficient, in improving accuracy of a machine learning model, to train the machine learning model using those instances. Therefore, by integrating synthetic instances that satisfy a similarity condition, the present example embodiment makes it possible to generate, in a region which is short of a training instance, a synthetic instance that can more efficiently improve accuracy of a machine learning model.

### Fourth Example Embodiment

The following description will discuss a fourth example embodiment of the present invention in detail with reference to the drawings. The same reference numerals are given to constituent elements which have functions identical with those described in the second example embodiment, and descriptions as to such constituent elements are not repeated. The present example embodiment is an example embodiment obtained by altering the generation section 24 in the second example embodiment as follows.

### <Configuration of Generation Section>

In the present example embodiment, the generation section 24 outputs, among generated synthetic instances, a synthetic instance which derives variation in a plurality of prediction results obtained by using the machine learning model group COM0 which has been trained. Here, the synthetic instance which derives variation is a synthetic instance for which a result of variation evaluation indicates that “variation is large”. Details of the evaluation of variation are as described above, and therefore the details will not be repeated. In other words, the generation section 24 carries out ex-post facto evaluation of variation for the generated synthetic instances using the machine learning model group COM0 which has been trained, and employs a synthetic instance which has found, by the ex-post facto evaluation, to derive variation in prediction results.

### <Flow of Information Processing Method>

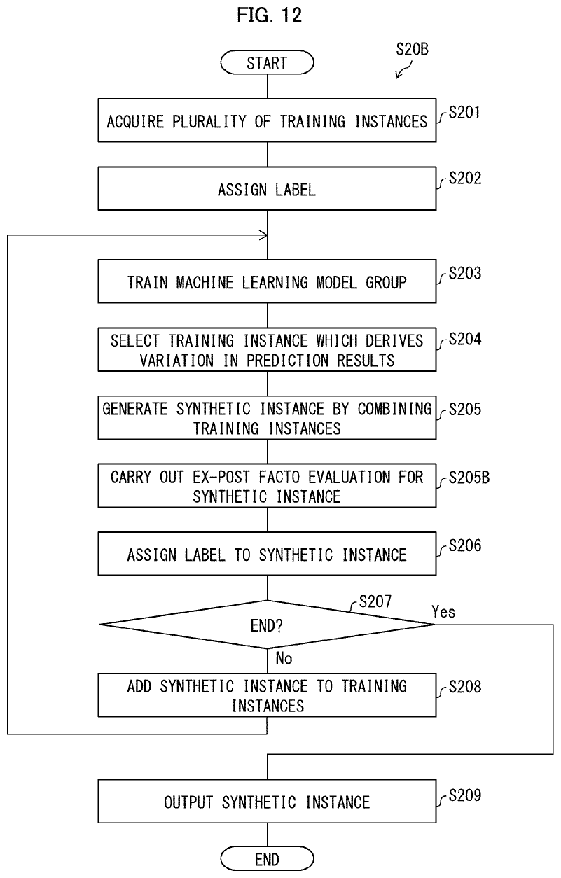

The following description will discuss an information processing method S20B in the present example embodiment, with reference to FIG. 12. FIG. 12 is a flowchart illustrating a flow of the information processing method S20B in accordance with the fourth example embodiment. The information processing method S20B illustrated in FIG. 12 is configured in a manner substantially similar to the information processing method S20 in accordance with the second example embodiment, except for a feature of further including step S205B.

### (Step S205B)

In step S205B, the generation section 24 carries out ex-post facto evaluation of a synthetic instance generated in step S205.

Specifically, the generation section 24 evaluates, for the synthetic instance of interest, variation in prediction results using the machine learning model group COM0. For example, in the example illustrated in FIG. 7, the generation section 24 evaluates variation in prediction results for the synthetic instance tv1-1 using the machine learning model group COM1. As such, it is preferable that the machine learning model group COM1 used in evaluation of variation is one used in evaluation of the training instance t1 which has been referred to in order to generate the synthetic instance tv1-1. Details of the process of evaluating variation in prediction results using the machine learning model group COM0 are as described in the second example embodiment.

In a case where a synthetic instance generated in step S205 has been evaluated not to derive large variation in prediction results, the generation section 24 deletes that synthetic instance. Here, deleting a synthetic instance is to remove the synthetic instance from subjects to each of which a label is to be assigned in step S206 and from subjects to be added to training instances in step S208. As such, a label is assigned to a synthetic instance which derives variation in prediction results, and the synthetic instance is added to training instances.

### Example Advantage of Present Example Embodiment

The present example embodiment employs the configuration in which the generation section outputs, among generated synthetic instances, a synthetic instance which derives variation in a plurality of prediction results obtained by using a machine learning model group which has been trained.

Here, a synthetic instance obtained by combining a plurality of training instances including a training instance which derives variation in prediction results does not necessarily derive variation in prediction results. In other words, the synthetic instance thus generated may derive small variation in prediction results. It is not efficient, in improving accuracy of a machine learning model, to train the machine learning model using a training instance which derives small variation in prediction results. Therefore, by carrying out ex-post facto evaluation for the generated synthetic instance, the present example embodiment makes it possible to generate, in a region which is short of a training instance, a synthetic instance that can more efficiently improve accuracy of a machine learning model.

### Fifth Example Embodiment

The following description will discuss a fifth example embodiment of the present invention in detail with reference to the drawings. The same reference numerals are given to constituent elements which have functions identical with those described in the second example embodiment, and descriptions as to such constituent elements are not repeated.

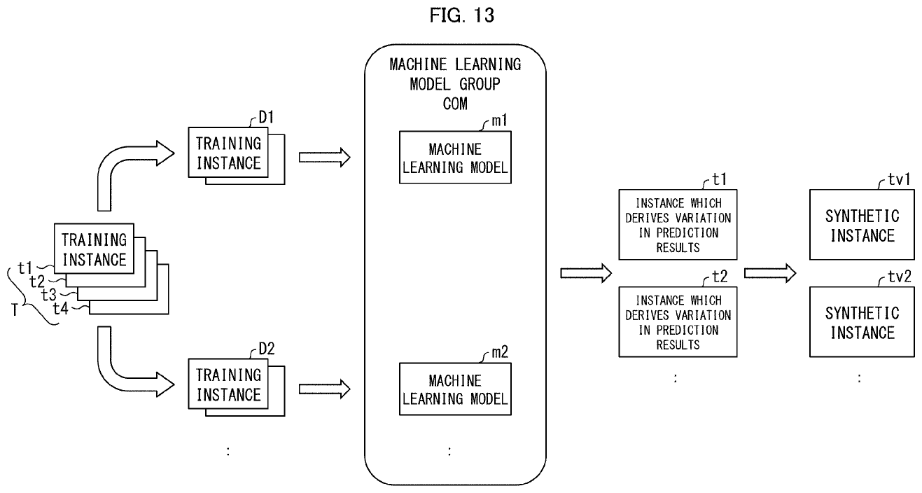

The present example embodiment is an example embodiment obtained by altering the configuration of the machine learning model group COM0 and steps S203 and S204 in the information processing method S20 in the second example embodiment as follows. The following description will discuss the present example embodiment, with reference to FIG. 13. FIG. 13 is a diagram schematically illustrating an information processing method in accordance with the present example embodiment.

### (Machine Learning Model Group)

As illustrated in FIG. 13, in the present example embodiment, the machine learning model group COM0 includes machine learning models mj (j=1, 2, . . . , M). The machine learning models mj are models generated by a single machine learning algorithm. For example, each of the machine learning models mj may be a decision tree.

### (Step S203)

In step S203 of the present example embodiment, the training section 22 extracts a training instance group Dj from a training instance group T which has been acquired by the acquisition section 21 in step S201. The training instance group Dj is a part of the training instance group T. For example, the training section 22 may extract the training instance group Dj by random sampling. The training section 22 repeats, for j=1, 2, . . . , M, training of each machine learning model mj with use of the training instance group Di.

Here, training instances included in a training instance group Dj1 may be all identical with training instances included in a training instance group Dj2. Note, however, that it is preferable that the training instances included in the training instance group Dj1 are partially or entirely different from the training instances included in the training instance group Dj2 (j1=1, 2, . . . , M; j2=1, 2, . . . , M; j1≠j2). By using the training instance groups Dj1 and Dj2 which are at least partially different from each other, machine learning model groups mj1 and mj2 are trained such that the machine learning model groups mj1 and mj2 are constituted by different parameters.

### (Step S204)

In step S204 of the present example embodiment, the selection section 23 evaluates, with use of the machine learning model group COM0, variation in prediction results for each of the training instances included in the training instance group T. Moreover, the selection section 23 selects a training instance which derives variation in prediction results. In the example illustrated in FIG. 13, the selection section 23 selects, with use of the machine learning model group COM0, training instances t1, t3, and so forth each of which derives variation in prediction results.

The process of step S205 is as described in the second example embodiment. That is, in the example illustrated in FIG. 13, one of the first generation process, the second generation process, and the third generation process is carried out for each of the training instances t1, t2, and so forth each of which derives variation in prediction results. Thus, synthetic instances tv1, tv2, and so forth are generated.

### Example Advantage of Present Example Embodiment

The present example embodiment employs the configuration in which, as machine learning models constituting a machine learning model group, models which have been all generated by a single machine learning algorithm are used, and a training instance which derives variation in prediction results is selected from an acquired training instance group.

Therefore, the present example embodiment makes it possible to generate, over the entire training instance group which has been acquired, a synthetic instance in a region which is short of a training instance.

Moreover, in the present example embodiment, in a case where all machine learnings included in the machine learning model group are decision trees, it is possible to generate more effective synthetic instances by improvement in accuracy of those machine learning models. This is because of the following reason. A decision tree can vary greatly in structure of a period with respect to a small alteration in a training instance. Therefore, by using a machine learning model group that includes a plurality of decision trees, it is possible to select, with higher accuracy, a training instance which derives variation in prediction results.

### Software Implementation Example

Some or all of the functions of each of the information processing apparatuses 10 and 20 may be implemented by hardware such as an integrated circuit (IC chip), or may be implemented by software.

In the latter case, each of the information processing apparatuses 10 and 20 is implemented by, for example, a computer that executes instructions of a program that is software realizing the foregoing functions. FIG. 15 illustrates an example of such a computer (hereinafter, referred to as “computer C”). The computer C includes at least one processor C1 and at least one memory C2. The memory C2 stores a program P for causing the computer C to function as the information processing apparatuses 10 and 20. In the computer C, the processor C1 reads the program P from the memory C2 and executes the program P, so that the functions of the information processing apparatuses 10 and 20 are implemented.

Examples of the processor C1 include a central processing unit (CPU), a graphic processing unit (GPU), a digital signal processor (DSP), a micro processing unit (MPU), a floating point number processing unit (FPU), a physics processing unit (PPU), a microcontroller, and a combination thereof. Examples of the memory C2 include a flash memory, a hard disk drive (HDD), a solid state drive (SSD), and a combination thereof.

Note that the computer C can further include a random access memory (RAM) in which the program P is loaded when the program P is executed and in which various kinds of data are temporarily stored. The computer C can further include a communication interface for carrying out transmission and reception of data with other apparatuses. The computer C can further include an input-output interface for connecting input-output apparatuses such as a keyboard, a mouse, a display and a printer.

The program P can be stored in a computer C-readable, non-transitory, and tangible storage medium M. The storage medium M can be, for example, a tape, a disk, a card, a semiconductor memory, a programmable logic circuit, or the like. The computer C can obtain the program P via the storage medium M. The program P can be transmitted via a transmission medium. The transmission medium can be, for example, a communication network, a broadcast wave, or the like. The computer C can obtain the program P also via such a transmission medium.

### [Additional Remark 1]

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

### [Additional Remark 2]

Some or all of the foregoing example embodiments can also be described as below. Note, however, that the present invention is not limited to the following supplementary notes.

### (Supplementary Note 1)

An information processing apparatus, including: an acquisition means for acquiring a plurality of training instances; a training means for training, with use of the plurality of training instances, a machine learning model group that includes a plurality of machine learning models each of which outputs a prediction result while using instances as input; a selection means for selecting, among the plurality of training instances, a training instance which derives variation in a plurality of prediction results obtained by using the machine learning model group which has been trained; and a generation means for generating a synthetic instance by combining, among the plurality of training instances, two or more training instances including the training instance which has been selected.

According to the configuration, a synthetic instance is generated using a training instance which derives variation in prediction results. Therefore, synthetic instances are not generated more in a region such as a region near a decision boundary, and a synthetic instance can be generated accurately in a region which is short of a training instance.

### (Supplementary Note 2)

The information processing apparatus according to supplementary note 1, in which: the generation means generates the synthetic instance by combining the training instance which has been selected and an instance which is present, in a feature quantity space, near the training instance which has been selected.

According to the configuration, a synthetic instance is generated near a training instance which derives variation in prediction results. Therefore, a synthetic instance can be generated accurately in a region which is short of a training instance.

### (Supplementary Note 3)

The information processing apparatus according to supplementary note 1, in which: the selection means selects, among the plurality of training instances, two or more training instances each of which derives variation in the plurality of prediction results; and the generation means generates the synthetic instance by combining the two or more training instances which have been selected.

According to the configuration, a synthetic instance is generated by combining training instances each of which derives variation in prediction results. Therefore, a synthetic instance can be generated accurately in a region which is short of a training instance.

### (Supplementary Note 4)

The information processing apparatus according to supplementary note 1, in which: the generation means generates the synthetic instance by carrying out one of a first generation process of combining the training instance which has been selected and an instance which is present, in a feature quantity space, near the training instance which has been selected, and a second generation process of generating the synthetic instance by combining two or more training instances which have been selected.

According to the configuration, a synthetic instance is generated by selectively using one of the first generation process and the second generation process. Therefore, in a case where a plurality of synthetic instances are generated, it is possible to generate synthetic instances in more various regions which are short of training instances.

### (Supplementary Note 5)

The information processing apparatus according to any one of supplementary notes 1 through 4, in which: the synthetic instance is added to the plurality of training instances, and the acquisition means, the training means, the selection means, and the generation means are caused to function again.

According to the configuration, training of the machine learning model group is repeated with use of training instances to which the generated synthetic instance has been added. Therefore, it is possible to select, with higher accuracy, a training instance which derives variation in prediction results. As a result, it is possible to generate a synthetic instance in a region that is more short of a synthetic instance.

### (Supplementary Note 6)

The information processing apparatus according to any one of supplementary notes 1 through 4, in which: the generation means generates a plurality of synthetic instances, and integrates, into a single synthetic instance, two synthetic instances that satisfy a similarity condition among the plurality of synthetic instances.

In a case of training a machine learning model using the synthetic instance integrated by the above configuration, it is possible to avoid training using a synthetic instance which is similar to a synthetic instance that has already been used. Therefore, it is possible to generate a synthetic instance that makes it possible to more efficiently improve accuracy of a machine learning model.

### (Supplementary Note 7)

The information processing apparatus according to any one of supplementary notes 1 through 6, in which: the generation means outputs, among the synthetic instances, a synthetic instance which derives variation in a plurality of prediction results obtained by using the machine learning model group which has been trained.

In a case of training a machine learning model using a synthetic instance which has been output by the above configuration, it is possible to avoid training using a synthetic instance which derives small variation in prediction results. Therefore, it is possible to generate a synthetic instance that makes it possible to more efficiently improve accuracy of a machine learning model.

### (Supplementary Note 8)

The information processing apparatus according to any one of supplementary notes 1 through 7, in which: the machine learning model group includes a machine learning model which is to be trained using the synthetic instance.

By training a machine learning model to be trained using a synthetic instance which has been generated by the above configuration, it is possible to more effectively improve accuracy of the machine learning model to be trained.

### (Supplementary Note 9)

The information processing apparatus according to any one of supplementary notes 1 through 8, in which: at least two machine learning models included in the machine learning model group use machine learning algorithms which are different from each other.

According to the configuration, it is possible to select more various training instances each of which derives variation in prediction results.

### (Supplementary Note 10)

The information processing apparatus according to any one of supplementary notes 1 through 8, in which: the machine learning model group uses a single machine learning algorithm.

According to the configuration, it is possible to select, with higher accuracy, a training instance which derives variation in prediction results.

### (Supplementary Note 11)

The information processing apparatus according to any one of supplementary notes 1 through 10, in which: at least one machine learning model in the machine learning model group is a decision tree.

According to the configuration, it is possible to generate a synthetic instance that makes it possible to more effectively improve accuracy of a decision tree.

### (Supplementary Note 12)

The information processing apparatus according to any one of supplementary notes 1 through 11, further including: a label assignment means for assigning a label to each of at least one of or all of the plurality of training instances and the synthetic instance.

According to the configuration, it is possible to train a machine learning model group or a machine learning model to be trained, with use of a training technique which is premised on an assumption that a label is assigned to an instance.

### (Supplementary Note 13)

An information processing method, including: acquiring a plurality of training instances; training, with use of the plurality of training instances, a machine learning model group that includes a plurality of machine learning models each of which outputs a prediction result while using instances as input; selecting, among the plurality of training instances, a training instance which derives variation in a plurality of prediction results obtained by using the machine learning model group which has been trained; and generating a synthetic instance by combining, among the plurality of training instances, two or more training instances including the training instance which has been selected.

According to the configuration, an example advantage similar to that of supplementary note 1 is brought about.

### (Supplementary Note 14)

A program for causing a computer to function as an information processing apparatus, the program causing the computer to function as: an acquisition means for acquiring a plurality of training instances; a training means for training, with use of the plurality of training instances, a machine learning model group that includes a plurality of machine learning models each of which outputs a prediction result while using instances as input; a selection means for selecting, among the plurality of training instances, a training instance which derives variation in a plurality of prediction results obtained by using the machine learning model group which has been trained; and a generation means for generating a synthetic instance by combining, among the plurality of training instances, two or more training instances including the training instance which has been selected.

According to the configuration, an example advantage similar to that of supplementary note 1 is brought about.

### (Supplementary Note 15)

A computer-readable storage medium storing a program described in supplementary note 14.

According to the configuration, an example advantage similar to that of supplementary note 1 is brought about.

### [Additional Remark 3]

Furthermore, some of or all of the foregoing example embodiments can also be expressed as below.

An information processing apparatus, including at least one processor, the at least one processor carrying out: an acquisition process of acquiring a plurality of training instances; a training process of training, with use of the plurality of training instances, a machine learning model group that includes a plurality of machine learning models each of which outputs a prediction result while using instances as input; a selection process of selecting, among the plurality of training instances, a training instance which derives variation in a plurality of prediction results obtained by using the machine learning model group which has been trained; and a generation process of generating a synthetic instance by combining, among the plurality of training instances, two or more training instances including the training instance which has been selected.

Note that the information processing apparatus can further include a memory. The memory can store a program for causing the at least one processor to carry out the . . . process, the . . . process, and the . . . process. The program can be stored in a computer-readable non-transitory tangible storage medium.

### REFERENCE SIGNS LIST

10, 20: Information processing apparatus
11, 21: Acquisition section
12, 22: Training section
13, 23: Selection section
14, 24: Generation section
25: Label assignment section
26: Output section
27: Control section

What is claimed is:

1. An information processing apparatus: comprising at least one processor, the at least one processor carrying out:
an acquisition process of acquiring a plurality of training instances;
a training process of training, with use of the plurality of training instances, a machine learning model group that includes a plurality of machine learning models each of which outputs a prediction result while using instances as input;
a selection process of selecting, among the plurality of training instances, a training instance which derives variation in a plurality of prediction results obtained by using the machine learning model group which has been trained; and
a generation process of generating a synthetic instance by combining, among the plurality of training instances, two or more training instances including the training instance which has been selected.

2. The information processing apparatus according to claim 1, wherein:
in the generation process, the at least one processor generates the synthetic instance by combining the training instance which has been selected and an instance which is present, in a feature quantity space, near the training instance which has been selected.

3. The information processing apparatus according to claim 1, wherein:
in the selection process, the at least one processor selects, among the plurality of training instances, two or more training instances each of which derives variation in the plurality of prediction results; and
in the generation process, the at least one processor generates the synthetic instance by combining the two or more training instances which have been selected.

4. The information processing apparatus according to claim 1, wherein:
in the generation process, the at least one processor generates the synthetic instance by carrying out one of
a first generation process of combining the training instance which has been selected and an instance which is present, in a feature quantity space, near the training instance which has been selected, and
a second generation process of generating the synthetic instance by combining two or more training instances which have been selected.

5. The information processing apparatus according to claim 1, wherein:
the synthetic instance is added to the plurality of training instances, and the acquisition process, the training process, the selection process, and the generation process are carried out again.

6. The information processing apparatus according to claim 1, wherein:
in the generation process, the at least one processor generates a plurality of synthetic instances, and integrates, into a single synthetic instance, two synthetic instances that satisfy a similarity condition among the plurality of synthetic instances.

7. The information processing apparatus according to claim 1, wherein:
in the generation process, the at least one processor outputs, among the synthetic instances, a synthetic instance which derives variation in a plurality of prediction results obtained by using the machine learning model group which has been trained.

8. The information processing apparatus according to claim 1, wherein:
the machine learning model group includes a machine learning model which is to be trained using the synthetic instance.

9. The information processing apparatus according to claim 1, wherein:
at least two machine learning models included in the machine learning model group use machine learning algorithms which are different from each other.

10. The information processing apparatus according to claim 1, wherein:
the machine learning model group uses a single machine learning algorithm.

11. The information processing apparatus according to claim 1, wherein:
at least one machine learning model in the machine learning model group is a decision tree.

12. The information processing apparatus according to claim 1, wherein:
the at least one processor further carries out a label assignment process of assigning a label to each of at least one of or all of the plurality of training instances and the synthetic instance.

13. An information processing method, comprising:
acquiring, by at least one processor, a plurality of training instances;
training, with use of the plurality of training instances by the at least one processor, a machine learning model group that includes a plurality of machine learning models each of which outputs a prediction result while using instances as input;
selecting, among the plurality of training instances by the at least one processor, a training instance which derives variation in a plurality of prediction results obtained by using the machine learning model group which has been trained; and
generating, by the at least one processor, a synthetic instance by combining, among the plurality of training instances, two or more training instances including the training instance which has been selected.

14. A non-transitory storage medium storing a program for causing a computer to function as an information processing apparatus, the program causing the computer to carry out:
an acquisition process of acquiring a plurality of training instances;
a training process of training, with use of the plurality of training instances, a machine learning model group that includes a plurality of machine learning models each of which outputs a prediction result while using instances as input;
a selection process of selecting, among the plurality of training instances, a training instance which derives variation in a plurality of prediction results obtained by using the machine learning model group which has been trained; and
a generation process of generating a synthetic instance by combining, among the plurality of training instances, two or more training instances including the training instance which has been selected.
